(19) United States
(12) Patent Application Publication
(10) Pub. No.: US 2025/0124572 A1
(43) Pub. Date: Apr. 17, 2025

(54) INFORMATION PROCESSING APPARATUS, INFORMATION PROCESSING METHOD, AND STORAGE MEDIUM

(71) Applicants: National Cancer Center, Tokyo (JP); Canon Kabushiki Kaisha, Tokyo (JP); CANON MEDICAL SYSTEMS CORPORATION, Otawara-shi (JP)

(72) Inventors: Miyuki SONE, Chuo (JP); Fukashi YAMAZAKI, Kawasaki (JP); Chihiro HATTORI, Nasushiobara (JP)

(73) Assignees: National Cancer Center, Tokyo (JP); Canon Kabushiki Kaisha, Tokyo (JP); CANON MEDICAL SYSTEMS CORPORATION, Otawara-shi (JP)

(21) Appl. No.: 18/916,059

(22) Filed: Oct. 15, 2024

(30) Foreign Application Priority Data
Oct. 16, 2023 (JP) 2023-178046

(51) Int. Cl. G06T 7/00; G06T 7/50; G06T 7/62; G06T 15/00; G06V 10/44; G06V 10/75

(52) U.S. Cl. CPC G06T 7/0012; G06T 7/50; G06T 7/62; G06T 15/00; G06V 10/44; G06V 10/758; G06T 2207/30004

(57) ABSTRACT

An information processing apparatus according to an embodiment includes processing circuitry. The processing circuitry acquires acquire three-dimensional tomographic image data in which a pancreas is depicted. The processing circuitry acquires profile line data that is able to specify a profile line running in the pancreas corresponding to the three-dimensional tomographic image data. The processing circuitry acquires a feature value along the profile line corresponding to the three-dimensional tomographic image data. The processing circuitry acquires an amount of change in a plurality of the feature values along the profile line. The processing circuitry localizes an abnormal region candidate, based on the amount of change.

### CROSS-REFERENCE TO RELATED APPLICATIONS

This application is based upon and claims the benefit of priority from Japanese Patent Application No. 2023-178046, filed on Oct. 16, 2023; the entire contents of which are incorporated herein by reference.

### FIELD

Embodiments disclosed herein with reference to the drawings relate generally to an information processing apparatus, an information processing method, and a storage medium.

### BACKGROUND

In general, pancreatic cancer is difficult to detect and has a very poor prognosis. In view of this, it has been desirable to establish a diagnostic support technology for early detection. In recent years, with the development of deep learning, more and more researches have come to be conducted on techniques to detect regions where pancreatic cancer is suspected, from medical images. For example, Zhuotun Zhu et al., “Multi-Scale Coarse-to-Fine Segmentation for Screening Pancreatic Ductal Adenocarcinoma”, arXiv: 1807. 02941 [cs. CV], 2019 suggests a method for segmenting regions where pancreatic cancer is suspected using CNN, which is one kind of deep learning.

However, pancreatic cancer in medical images is often obscure, and even methods using deep learning fail to detect regions where pancreatic cancer is suspected. On the other hand, indirect findings that are important for the early detection of pancreatic cancer include dilation or disruption of the main pancreatic duct and stenosis of the pancreas. Using these pieces of information may improve detection accuracy for the obscure pancreatic cancer.

### BRIEF DESCRIPTION OF THE DRAWINGS

FIG. 1 is a diagram illustrating one example of a function structure of an information processing apparatus according to a first embodiment;

FIG. 2 is a diagram illustrating one example of a hardware structure of the information processing apparatus according to the first embodiment;

FIG. 3 is a diagram for describing CT image data according to the first embodiment;

FIG. 4 is a diagram for describing a profile line held by profile line data according to the first embodiment;

FIG. 5 is a flowchart expressing one example of a procedure of a process of the information processing apparatus according to the first embodiment;

FIG. 6 is a flowchart expressing one example of a procedure of a feature value calculating process according to the first embodiment;

FIG. 7 is one example of a graph plotting an amount of change of a feature value along the profile line with respect to the feature value in the first embodiment;

FIG. 8 is one example of a graph plotting the amount of change of the feature value along the profile line with respect to the feature value in the first embodiment;

FIG. 9 is a diagram illustrating one example of a display mode by the information processing apparatus according to the first embodiment;

FIG. 10 is a diagram illustrating one example of a function structure of an information processing apparatus according to a second embodiment;

FIG. 11 is a flowchart expressing one example of a procedure of a process of the information processing apparatus according to the second embodiment;

FIG. 12 is a flowchart expressing one example of a procedure of a feature value calculating process according to the second embodiment;

FIG. 13 is a diagram illustrating one example of a function structure of an information processing apparatus according to a third embodiment; and

FIG. 14 is a flowchart expressing one example of a procedure of a process of the information processing apparatus according to the third embodiment.

### DETAILED DESCRIPTION

Embodiments of an information processing apparatus, an information processing method, and a computer program will hereinafter be described in detail with reference to the drawings. Identical or equivalent components, parts, and processes illustrated in each drawing have the same symbols, and duplicate explanations will be omitted as appropriate. In each drawing, some components, parts, and processes are omitted as appropriate.

An information processing apparatus according to an embodiment includes processing circuitry. The processing circuitry acquires acquire three-dimensional tomographic image data in which a pancreas is depicted. The processing circuitry acquires profile line data that is able to specify a profile line running in the pancreas corresponding to the three-dimensional tomographic image data. The processing circuitry acquires a feature value along the profile line corresponding to the three-dimensional tomographic image data. The processing circuitry acquires an amount of change in a plurality of the feature values along the profile line. The processing circuitry localizes an abnormal region candidate, based on the amount of change.

In each of the following embodiments, computed tomography (CT) image data taken with an X-ray computed tomography (X-ray CT) device will be used as an example of three-dimensional tomographic image data. The embodiments of the present disclosure are not limited to the following embodiments, and can be applied, for example, to images taken with a nuclear magnetic resonance imaging (MRI) device, a positron emission tomography (PET) device, and an ultrasound diagnosis device.

### First Embodiment

### Summary

The present embodiment will describe a method for calculating a feature value of an image along a profile line that runs in a pancreas in CT image data, and by using this feature value, detecting an abnormal region candidate and an abnormal region.

More specifically, an average value of intensity (CT value) calculated based on a window in an arbitrary size is acquired as the feature value along the profile line in the pancreas for each of the voxels of the CT image data on the profile line. A first derivation between the feature values is calculated for the feature values along the profile line, and if the absolute value of the first derivation is more than or equal to a predetermined threshold, an abnormal region candidate is detected. Here, the absolute value of the first derivation is, in other words, the amount of change in the feature values. In the present embodiment, additionally, a recognizer determines whether the abnormal region candidate is an abnormal region and localizes the abnormal region. The average value of intensity is one example of a statistic of the intensity in the present embodiment. The recognizer is one example of an inference model based on machine learning in the present embodiment. Function structure

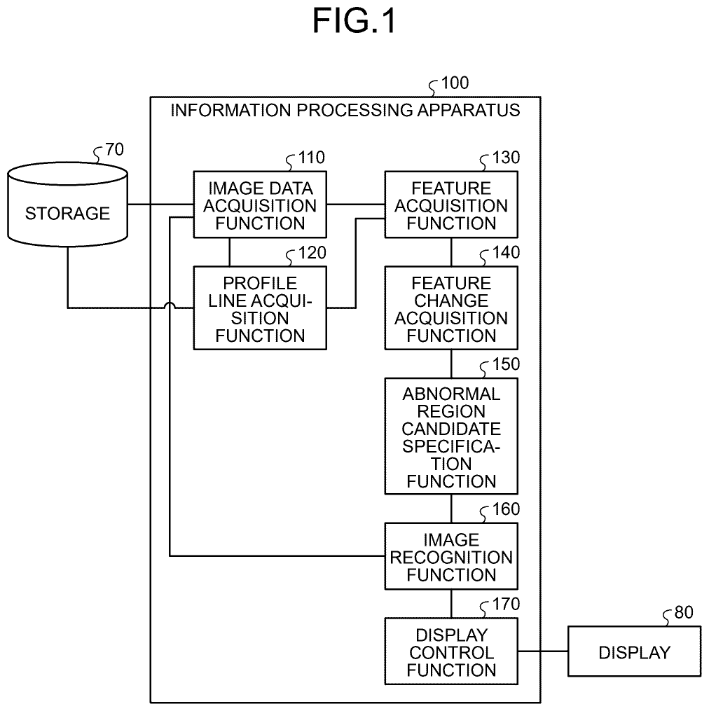

With reference to FIG. 1, a function structure of an information processing apparatus 100 according to the present embodiment is described below. As illustrated in this drawing, the information processing apparatus 100 includes an image data acquisition function 110, a profile line acquisition function 120, a feature value acquisition function 130, a feature value change acquisition function 140, an abnormal region candidate localization function 150, an image recognition function 160, and a display control function 170. The information processing apparatus 100 according to the present embodiment also includes a storage 70 and a display 80 externally. The storage 70 and the display 80 may be included in the structure of the information processing apparatus 100. The storage 70 may be provided inside the information processing apparatus 100.

The storage 70 is one example of a computer-readable storage medium and is a non-transitory mass storage, typified by a hard disk drive (HDD) or solid state drive (SSD). The storage 70 holds CT image data and profile line data of the pancreas corresponding to the CT image data.

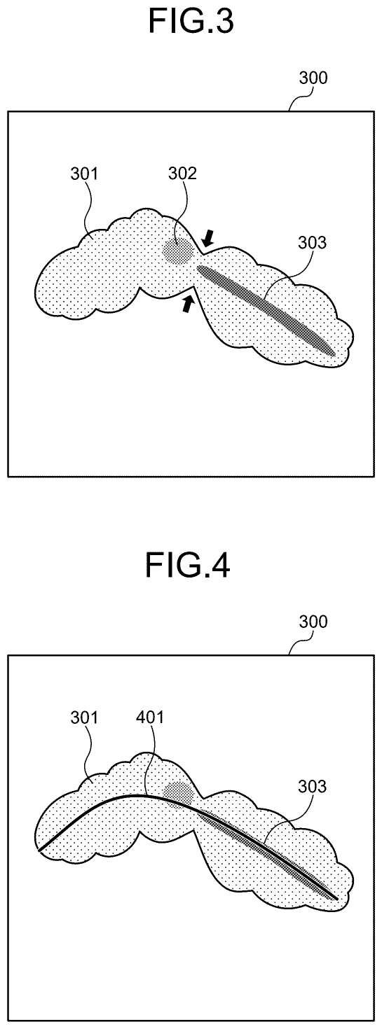

Here, with reference to FIG. 3 and FIG. 4, the CT image data and the profile line data in the present embodiment are described. In FIG. 3 and FIG. 4, the profile line of the pancreas ranging from the pancreatic head to the pancreatic tail is expressed in the drawings; however, this is just a simplified representation for the sake of illustration. The actual profile line is a three-dimensional curve and does not necessarily exist in the same plane.

FIG. 3 is a drawing for describing CT image data 300 according to the present embodiment. In the CT image data 300, a pancreas 301 is depicted, with the left side of the drawing representing the pancreatic head side and the right side representing the pancreatic tail side. Moreover, in the CT image data 300, a main pancreatic duct 303 and pancreatic cancer 302 are depicted inside the pancreas 301. In the main pancreatic duct 303, pancreatic juice flows from the pancreatic tail side to the pancreas head side. In the case illustrated in FIG. 3, the pancreatic cancer 302 obstructs the main pancreatic duct 303, which causes poor flow of the pancreatic juice in the main pancreatic duct 303. In this case, dilation occurs until the main pancreatic duct 303 is clearly depicted on the pancreatic tail side, and the main pancreatic duct 303 is disrupted just before the pancreatic cancer 302. In general, the pancreatic cancer and the inside of the main pancreatic duct are depicted with lower CT values than the normal pancreatic parenchyma. Therefore, these tissues (main pancreatic duct 303 and pancreatic cancer 302) are depicted in a denser color than the pancreatic parenchyma in the CT image data 300 illustrated in FIG. 3. FIG. 3 also illustrates a localized stenosis of the pancreas 301 at a location around the pancreatic cancer 302 indicated by arrows. Since the dilation of the main pancreatic duct and localized stenosis of the pancreas are indirect findings of the pancreatic cancer, these pieces of information can be used to improve the detection performance of the pancreatic cancer.

FIG. 4 is a diagram for describing a profile line 401 held by profile line data according to the present embodiment. In the present embodiment, “the profile line data holds the profile line 401” means, in other words, that the profile line data contains information that can specify the profile line 401. FIG. 4 illustrates that the profile line 401 is overlapped on the CT image data 300. The profile line 401 is, for example, a line that passes through a substantial center of the pancreas 301 so as to connect the pancreatic tail and the pancreatic head of the pancreas 301. The profile line 401 may be core line or a center line of the pancreas 301. As illustrated in FIG. 4, the profile line 401 in the present embodiment passes the inside of the main pancreatic duct 303. In the profile line data, the data is held in a format that can represent the profile line 401 as described above. For example, the profile line data holds three-dimensional coordinate values in the image coordinate system of a group of points that make up the profile line 401 or a group of control points for a curve such as a spline curve. The profile line data may alternatively be image data in which voxels that belong to the profile line and those that do not are represented by different voxel values. This profile line data is, for example, automatically generated by another information processing apparatus configured to perform a known image recognition method on the CT image data, or semi-automatically generated by manual operation by a physician or other person.

Referring back to FIG. 1, the image data acquisition function 110 acquires the CT image data of the pancreas from the storage 70 and transmits the CT image data to the feature value acquisition function 130, the image recognition function 160, and the display control function 170.

The profile line acquisition function 120 acquires the profile line data of the pancreas corresponding to the CT image data from the storage 70 and transmits the CT image data to the feature value acquisition function 130.

The feature value acquisition function 130 acquires the feature value along the profile line corresponding to the CT image data. More specifically, the feature value acquisition function 130 first receives the CT image data from the image data acquisition function 110 and receives the profile line data of the pancreas corresponding to the CT image data from the profile line acquisition function 120. Next, the feature value acquisition function 130 calculates the feature values along the profile line from the CT image data on the basis of the profile line data. The feature value acquisition function 130 then transmits the feature values along the profile line to the feature value change acquisition function 140.

The feature value change acquisition function 140 acquires the amount of change in a plurality of the feature values along the profile line. More specifically, the feature value change acquisition function 140 first receives the feature value along the profile line from the feature value acquisition function 130. Next, the feature value change acquisition function 140 acquires the amount of change of the feature value by calculating the amount of change in the local feature values with respect to the feature value along the profile line. The feature value change acquisition function 140 then transmits the amount of change of the feature value to the abnormal region candidate localization function 150.

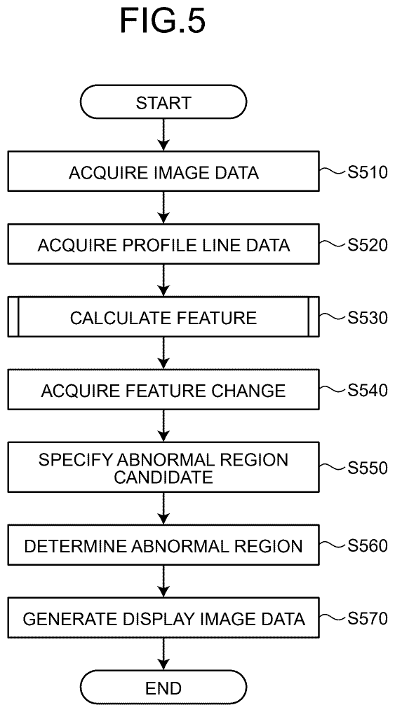

The abnormal region candidate localization function 150 localizes the abnormal region candidate near the profile line in the pancreas on the basis of the feature value. More specifically, the abnormal region candidate localization function 150 localizes the abnormal region candidate on the basis of the amount of change of the feature value acquired by the feature value change acquisition function 140. The abnormal region candidate localization function 150 first receives the amount of change of the feature value from the feature value change acquisition function 140. Next, the abnormal region candidate localization function 150 localizes the change point where the amount of change of the feature value satisfies a predetermined condition, and localizes (detects) a region including the change point as an abnormal region candidate. The abnormal region candidate localization function 150 generates image data representing the abnormal region candidate (abnormal region candidate image data) and transmits the abnormal region candidate image data to the image recognition function 160. The predetermined condition used to specify the change point is, for example, that the amount of change of the feature value is more than or equal to a threshold. The details of specifying the change point are described based on a flowchart in FIG. 5 below.

Here, the abnormal region candidate image data is described. The abnormal region candidate image data is image data that expresses whether each voxel is a voxel included in the abnormal region candidate. For example, the abnormal region candidate image data is a binary image with the same image size as the CT image data, in which the voxel value of a voxel included in the abnormal region candidate is expressed as 1 and that of a voxel not included in the abnormal region candidate is expressed as 0. The abnormal region candidate image data may be in any format as long as the abnormal region candidate depicted on the CT image data can be identified; therefore, the abnormal region candidate may be likelihood image data in which the voxel value of each voxel represents the likelihood of the abnormal region candidate. The abnormal region candidate image data may be multi-value image data in which the voxel values of the respective voxels express regions of various tissues including the abnormal region candidate in multiple values. The abnormal region candidate image data may alternatively be coordinate value data of the vertices when the abnormal region candidate is approximated as a polygon.

The image recognition function 160 first receives the CT image data from the image data acquisition function 110 and receives the abnormal region candidate image data from the abnormal region candidate localization function 150. Next, the image recognition function 160 localizes the abnormal region by determining whether the abnormal region candidate localized by the abnormal region candidate localization function 150 is the abnormal region with the use of a recognizer configured to be able to determine whether the abnormal region candidate on the CT image data is the abnormal region. Upon the reception of input of partial image data of the CT image data including the abnormal region candidate, the recognizer outputs a determination result as to whether the region depicted in the abnormal region candidate image data is the abnormal region. The image recognition function 160 inputs the abnormal region candidate image data to the recognizer and obtains the determination result output from the recognizer. The unit by which the recognizer determines the abnormality can be per voxel or per region including a specified number of voxels.

The image recognition function 160 then generates image data representing the localized abnormal region (abnormal region image data) and transmits the abnormal region image data to the display control function 170. The abnormal region image data is image data that holds the abnormal region in the format similar to that of the abnormal region candidate image data described above. Here, “the image data holds the abnormal region” means, in other words, that the image data contains information that can localize the abnormal region.

In the present embodiment, the recognizer is, for example, a trained convolutional neural network (CNN). The CNN, for example, is trained by a known method (error back propagation method, etc.) using teacher data including partial image data including the abnormal region candidate (input data) and data indicating whether the region is abnormal (correct data). For the abnormal region candidate, the image recognition function 160 stores in the abnormal region image data, only the region that has been determined to be the abnormal region by the above-mentioned recognizer. Note that the recognizer may be stored in the storage 70 separately from the image recognition function 160, or may be incorporated into the image recognition function 160.

The display control function 170 causes the display 80 to display, in the way that the identification is possible, at least one of the abnormal region candidate and the image recognition result, which is a result of the image recognition for the abnormal region candidate. For example, the display control function 170 first receives the CT image data from the image data acquisition function 110 and receives the abnormal region image data, which is the result of the image recognition, from the image recognition function 160. The display control function 170 then causes the display 80 to display the CT image data and the abnormal region image data.

### Hardware Structure

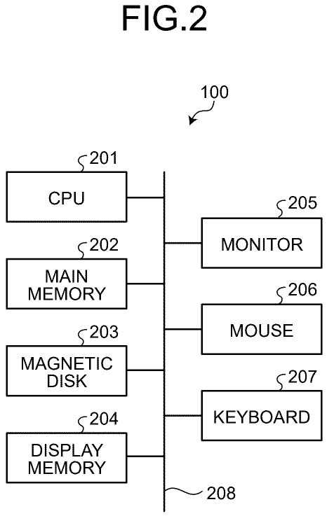

Subsequently, a hardware structure of the information processing apparatus 100 is described with reference to FIG. 2. FIG. 2 is a diagram illustrating one example of a hardware structure of the information processing apparatus 100 according to the first embodiment. The information processing apparatus 100 has a known computer (information processing apparatus) structure. The information processing apparatus 100 includes a CPU 201, a main memory 202, a magnetic disk 203, a display memory 204, a monitor 205, a mouse 206, and a keyboard 207 as its hardware structure.

The central processing unit (CPU) 201 mainly controls the operation of each component element. The main memory 202 stores control programs to be executed by the CPU 201 and provides a work area when the CPU 201 executes the computer program. The magnetic disk 203 stores therein an operating system (OS), device drivers for peripheral devices, and computer programs for realizing various application software, including computer programs for performing processes to be described below. The CPU 201 realizes the functions (software) of the information processing apparatus 100 illustrated in FIG. 1 and the processes in the flowchart to be described below by executing the computer programs stored in the main memory 202, the magnetic disk 203, etc. The magnetic disk 203 may be identical to the storage 70.

The display memory 204 temporarily stores data for display therein. The monitor 205 is a CRT monitor, a liquid crystal monitor, or the like, for example, and displays images, text, etc. on the basis of data from the display memory 204. The mouse 206 and the keyboard 207 convert the input operation received from a user into electric signals and output the electric signals to the CPU 201 for pointing input and text input by the user, respectively, for example. The above component elements are connected by a common bus 208 so that mutual communication is possible. The monitor 205 may be identical to the display 80. The mouse 206 and the keyboard 207 are examples of the input interfaces of the information processing apparatus 100 and may be replaced by other means. For example, the information processing apparatus 100 may have an input interface such as a track ball, a switch button, a touch pad on which an input operation is performed by a touch on an operation surface, a touch screen combining a display screen and a touch pad, a non-contact input circuit using an optical sensor, or a sound input circuit. Note that the input interface is not limited to those with physical operating components only. In another example, the information processing apparatus 100 may have, as the input interface, a processing circuit for electric signals configured to receive electric signals corresponding to an input operation from an external input device, which is provided separately from the information processing apparatus 100, and output the electric signals to a control circuit.

The CPU 201 corresponds to one example of the processor or the control unit. Note that the processor included in the information processing apparatus 100 is not limited to the CPU 201. The information processing apparatus 100 may have, for example, at least one of a graphics processing unit (GPU), an application specific integrated circuit (ASIC), a programmable logic device (for example, simple programmable logic device (SPLD)), a complex programmable logic device (CPLD), and a field programmable gate array (FPGA) in addition to the CPU 201 or instead of the CPU 201. If the processor is an ASIC, each of the functions illustrated in FIG. 1 (the image data acquisition function 110, the profile line acquisition function 120, the feature value acquisition function 130, the feature value change acquisition function 140, the abnormal region candidate localization function 150, the image recognition function 160, and the display control function 170) is directly incorporated as a logic circuit in the circuit of the processor instead of saving the computer programs in the main memory 202, the magnetic disk 203, or the like. Each processor in the present embodiment is not limited to the case where each processor is configured as a single circuit, and may alternatively be configured as a single processor by combining a plurality of independent circuits to realize the functions. Furthermore, a plurality of component elements may be integrated into a single processor to achieve the functions. The main memory 202 and the magnetic disk 203 correspond to one example of the memory or the storage.

### Procedure of Process

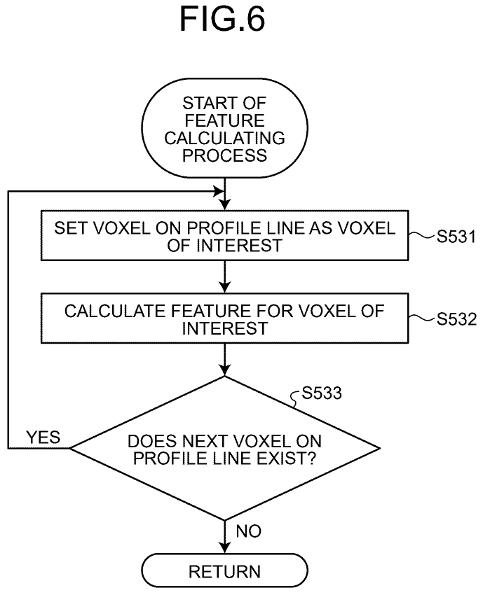

Next, a procedure of the process of the information processing apparatus 100 according to the present embodiment is described using FIG. 5 and FIG. 6. FIG. 5 is a flowchart expressing one example of the procedure of the process of the information processing apparatus 100 according to the first embodiment. FIG. 6 is a flowchart expressing one example of a procedure of a feature value calculating process according to the first embodiment.

### Step S510

At step S510, the image data acquisition function 110 acquires the CT image data from the storage 70. The image data acquisition function 110 then transmits the CT image data to the feature value acquisition function 130 and the display control function 170.

### Step S520

At step S520, the profile line acquisition function 120 acquires the profile line data from the storage 70. The profile line acquisition function 120 then transmits the profile line data to the feature value acquisition function 130. In the present embodiment, the profile line data is the three-dimensional coordinate value of each of a group of points that make up the profile line 401. The order of the point group in the profile line data is not restricted; however, in the present embodiment, the data arranged in the order from the pancreatic head to the pancreatic tail will be used as an example.

### Step S530

At step S530, the feature value acquisition function 130 receives the CT image data 300 from the image data acquisition function 110 and receives the profile line data of the pancreas corresponding to the CT image data 300 from the profile line acquisition function 120. Next, the feature value acquisition function 130 calculates the feature value along the profile line 401 from the CT image data 300 on the basis of the profile line data. The feature value is the value based on the voxel value on the profile line 401. More specifically, in the present embodiment, the feature value along the profile line is the average value of the intensity calculated based on a window in an arbitrary size for each of the voxels on the profile line. Although the window can be set arbitrarily, a three-dimensional rectangular window centered on a voxel on the profile line is used in the example of the present embodiment. The feature value acquisition function 130 then transmits the feature values along the profile line to the feature value change acquisition function 140. Here, the feature values along the profile line refer to a set of feature values in which the feature values calculated for the respective voxels on the profile line are arranged in the order along the profile line.

Here, with reference to the flowchart in FIG. 6, the details of the process of calculating the feature value at step S530 in the present embodiment are described.

### Step S531

At step S531, the feature value acquisition function 130 sets any voxel on the profile line as a voxel of interest. In the example described in the present embodiment, the feature values for the voxels on the profile line are calculated in the order from the pancreatic head to the pancreatic tail. Therefore, the feature value acquisition function 130 first sets the voxel at an end on the pancreatic head side among the voxels on the profile line, as the voxel of interest. Thereafter, when this processing step is performed again after steps S532 and S533, the voxel next to the voxel set above is set as the voxel of interest. In other words, as step S530, the process from step S531 to step S533 is repeated for the number of voxels on the profile line.

### Step S532

At step S532, the feature value acquisition function 130 calculates the feature value for the voxel of interest set at step S531. In the present embodiment, the feature value is to be calculated based on the voxel in the CT image included in the window in the arbitrary size centered on the voxel of interest, and specifically, a three-dimensional rectangular window with 5 voxels on a side will be used. In the method of calculating the feature value described here, the average value of the intensity of the voxels included in the window is used as the feature value. The shape and size of the window can be set arbitrarily according to the characteristics of the image, for example. The use of the average value of intensity as the feature value is just one example of the implementation of the present disclosure, and the calculation may be performed by any method.

### Step S533

At step S533, the feature value acquisition function 130 determines whether the next voxel on the profile line exists, and if the next voxel does not exist (No at S533), terminates step S530, and if otherwise (Yes at S533), the process returns to step S531 and the next voxel is set as the voxel of interest. In other words, the feature value acquisition function 130 terminates step S530 when the feature values are calculated for all voxels on the profile line.

In the present embodiment, the feature values for the voxels on the profile line are calculated in the order from the pancreatic head to the pancreatic tail; therefore, the next voxel is the voxel that has advanced in the direction of the pancreatic tail from the current voxel of interest. The voxel of interest at the end of step S530 is the voxel at the end on the pancreatic tail side among the voxels on the profile line.

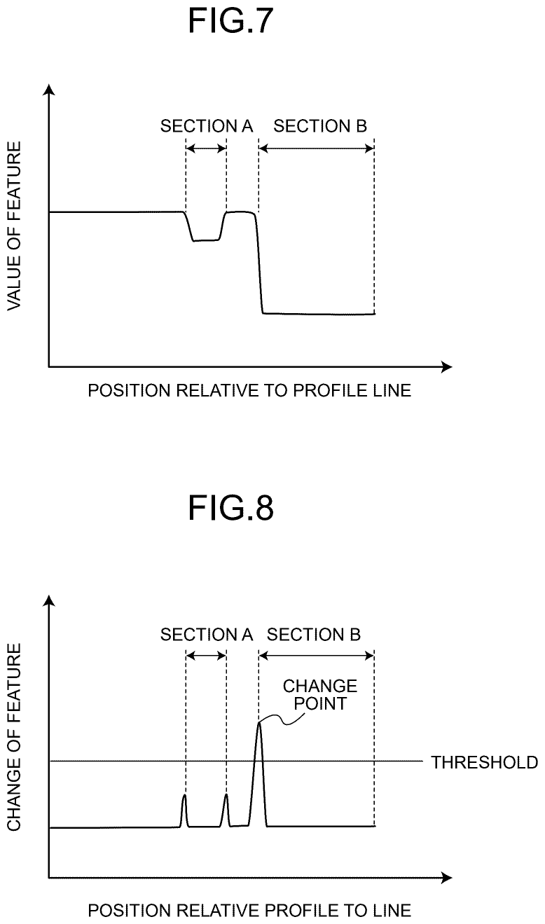

The relationship between the position of the voxel relative to the profile line and the value of the feature value is described here with reference to FIG. 7. FIG. 7 is one example of a graph plotting the amount of change of the feature value along the profile line with respect to the feature value in the first embodiment. With step S530 described above, the feature value acquisition function 130 acquires the feature values along the profile line as illustrated in FIG. 7. The value of the feature value in the drawing corresponds to the average value of the intensity of voxels in a predetermined range of the window centered on the voxel on the profile line in the present embodiment. In particular, a section A and a section B are the feature values (average value of intensity) corresponding to the region of the pancreatic cancer 302 and the region of the main pancreatic duct 303, respectively.

### Step S540

Referring back to the flowchart in FIG. 5, at step S540, the feature value change acquisition function 140 first receives the feature values along the profile line from the feature value acquisition function 130. Next, the feature value change acquisition function 140 acquires the amount of change of the feature value by calculating the amount of change in the local feature values with respect to the feature value along the profile line. The feature value change acquisition function 140 then transmits the amount of change of the feature value to the abnormal region candidate localization function 150.

In the present embodiment, the feature value change acquisition function 140 calculates the absolute value of the first derivation between the feature values with respect to the feature values along the profile line, and acquires this value as the amount of change of the feature value. In other words, the feature value change acquisition function 140 acquires the absolute value of the difference between the feature values for the adjacent voxels on the profile line as the amount of change of the feature value. In other words, the feature value change acquisition function 140 acquires the amount of change in the local feature values with respect to the feature values along the profile line.

The amount of change of the feature value is described here with reference to FIG. 8. FIG. 8 is one example of a graph plotting the amount of change of the feature value (average value of intensity) along the profile line calculated at step S530 with respect to the feature value. The amount of change of the feature value is high at the left end of the section B on the graph (the boundary between the main pancreatic duct 303 and the pancreatic parenchyma), followed by both ends of the section A (the boundary between the pancreatic cancer 302 and the parenchyma).

### Step S550

Referring back to FIG. 5, at step S550, the abnormal region candidate localization function 150 first receives the amount of change of the feature value from the feature value change acquisition function 140. Next, the abnormal region candidate localization function 150 specifies the change point at which the amount of change of the feature value satisfies the predetermined condition, and localizes the region including the change point as the abnormal region candidate. The abnormal region candidate localization function 150 generates the abnormal region candidate image data and transmits the abnormal region candidate image data to the image recognition function 160.

Here, the predetermined condition used to specify the change point is described. The pancreatic cancer that obstructs the main pancreatic duct is generally located near the position where the main pancreatic duct is no longer visible (position where the main pancreatic duct is obstructed) when the main pancreatic duct depicted in the CT image data is observed from the pancreatic tail to the pancreatic head. Furthermore, in a typical example, the pancreatic cancer exists at the position on the pancreatic head side relative to the aforementioned position. In other words, there is a positional relation like the one between the pancreatic cancer 302 and the main pancreatic duct 303 on the CT image data 300 illustrated in FIG. 3. Therefore, the abnormal region candidate localization function 150 in the present embodiment first specifies the voxel corresponding to the position (change point) where the amount of change of the average value of the intensity (feature value) along the profile line is more than or equal to a threshold. This corresponds to specifying “the position where the main pancreatic duct is no longer visible” as described above. In the example illustrated in FIG. 8, the end of the section B is specified as the change point by the determination based on the threshold; however, depending on the threshold, the end of the section A, where pancreatic cancer is present, can also be specified as the change point. Subsequently, the abnormal region candidate localization function 150 sets the voxel that is a predetermined distance away from the voxel corresponding to the change point (for example, a voxel 10 mm away to the pancreatic head side along the profile line) as a reference voxel of the abnormal region candidate. Then, the abnormal region candidate localization function 150 localizes a region of interest (ROI) centered on the reference voxel of the abnormal region candidate as the abnormal region candidate. The ROI can be of any shape and size, and in the present embodiment, the shape of the ROI is a three-dimensional rectangle and the size is a preset value. For example, the abnormal region candidate localization function 150 sets the size of the ROI on the basis of the statistic of the size of the pancreatic cancer. Based on the abnormal region candidate localized by the above process, the abnormal region candidate localization function 150 generates the abnormal region candidate image data that can localize the region in the CT image data. In the present embodiment, the abnormal region candidate image data is binary image data in which the abnormal region candidate has a voxel value of 1 and the non-abnormal region has a voxel value of 0.

### Step S560

At step S560, the image recognition function 160 first receives the CT image data from the image data acquisition function 110 and receives the abnormal region candidate image data from the abnormal region candidate localization function 150. Next, the image recognition function 160 localizes the abnormal region by determining whether the abnormal region candidate localized by the abnormal region candidate localization function 150 is the abnormal region with the use of a recognizer configured to be able to determine whether the abnormal region candidate is the abnormal region. The image recognition function 160 then generates the abnormal region image data and transmits the abnormal region image data to the display control function 170.

For the abnormal region candidate, the image recognition function 160 stores in the abnormal region image data, only the region that has been determined to be the abnormal region by the recognizer. In the present embodiment, the abnormal region image data is the binary image data in which the abnormal region has a voxel value of 1 and the non-abnormal region has a voxel value of 0.

### Step S570

At step S570, the display control function 170 first receives the CT image data from the image data acquisition function 110 and receives the abnormal region image data from the image recognition function 160. The display control function 170 then causes the display 80 to display the CT image data and the abnormal region image data.

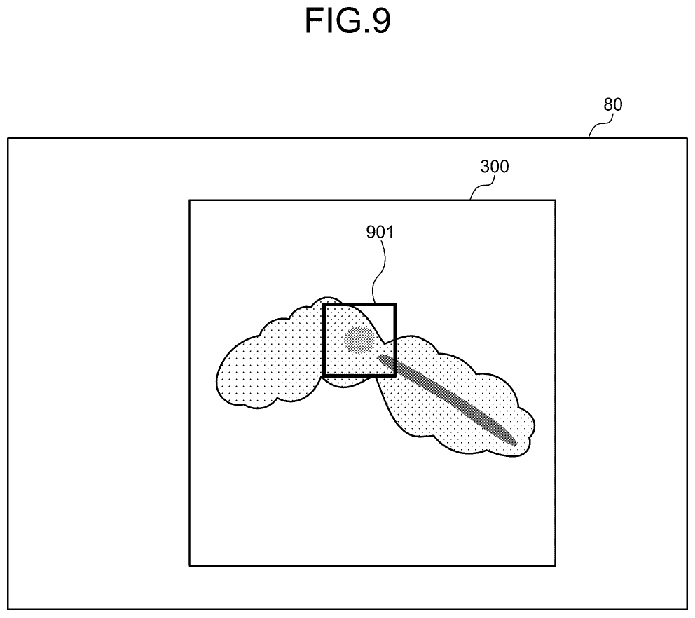

In the present embodiment, the display control function 170 causes the display 80 to display so that a rectangular frame line that surrounds the abnormal region (ROI) held by the abnormal region image data is overlapped on the CT image data 300. Here, FIG. 9 is a diagram illustrating one example of a display mode by the information processing apparatus 100 according to the first embodiment. FIG. 9 illustrates one example in which the display control function 170 causes the display 80 to display the CT image data 300 and an abnormal region 901. In this way, the display control function 170 makes the abnormal region identifiable on the CT image data in the display. Here, the process of the flowchart in FIG. 5 ends.

With the above procedure of the process, the information processing apparatus 100 calculates the amount of change of the intensity value of the voxel on the profile line on the basis of the CT image data and the profile line data of the pancreas, and localizes the abnormal region candidate in the pancreas on the basis of the amount of change. Then, for the localized abnormal region candidate, it is determined whether the region is abnormal. In this way, changes within the pancreas, such as indirect findings of pancreatic cancer, can be captured, and it is expected to improve the detection performance of the obscure pancreatic cancer.

That is to say, by the information processing apparatus 100 according to the present embodiment, the feature values along the profile line that runs in the pancreas corresponding to the CT image data, which is the three-dimensional tomographic image data in which the pancreas is depicted, are acquired and the abnormal region candidate near the profile line in the pancreas is specified based on the feature values; thus, the detection accuracy for the abnormal region candidate such as the pancreatic cancer can be improved.

### Variation of First Embodiment

In the above description, the profile line acquisition function 120 acquires the profile line corresponding to the CT image data from the storage 70; however, the implementation of the present disclosure is not limited to this. For example, the profile line acquisition function 120 may estimate and acquire the profile line from the CT image data using, for example, an image recognition method disclosed in C. Hattori et al., “Centerline detection and estimation of pancreatic duct from abdominal CT images”, Proc. SPIE 12032, Medical Imaging 2022.

In the description made above, the feature value acquisition function 130 acquires the feature value for the voxel on the profile line using the three-dimensional window in the arbitrary size as the feature value; however, the present disclosure is not limited to this. In other examples, the feature value may be acquired using a one-dimensional window or a two-dimensional window in any size, or the voxel value of the voxel on the profile line itself may be acquired as the feature value without using a window. When the one-dimensional window is used, for example, the window may be set up for the tangent direction of the profile line and the feature value in the window may be acquired, or the feature value may be acquired from the voxel in the window along the profile line (curve). In the case of calculating the feature value from the voxel in the window along the profile line, the feature value can be calculated at step S532 on the basis of the voxel values of several voxels in front and behind on the profile line, with the voxel of interest as the center. When the two-dimensional window is used, for example, the window may be set up for a cross section along the tangent direction of the profile line (a cross section stretched by the tangent direction axis and the direction axis orthogonal to the tangent line) and the feature value may be acquired. Alternatively, a window may be set up for at least one cross section that intersects (or cross section that is orthogonal to) the profile line to acquire the feature value. Further alternatively, for each voxel on the profile line, the result of integrating the feature values acquired in a plurality of windows with different spatial dimensions described above may be used as the feature value. The window set up for the cross section that intersects the profile line is one example of cross- sectional image data that intersects the profile line.

In the description made above, the feature value acquisition function 130 acquires the average value of intensity as the feature value; however, any feature value may be used as long as it is the statistic of intensity near the profile line. For example, a minimum value, a maximum value, a median value, a variance value, and a weighted average value of the intensity near a voxel on the profile line may be acquired as the feature value. In addition, the intensity distribution may be expressed as a histogram, and a vector of the same dimension as the number of bins in the histogram may be used as the feature value. In this case, the feature value change acquisition function 140 can acquire the distance between the vectors as the amount of change of the feature value. A plurality of the aforementioned feature values may be combined.

The feature value acquisition function 130 may calculate the feature value using any filter. For example, the feature value may be calculated using a smoothing filter such as a Gaussian filter in order to reduce the effect of noise near the profile line. Alternatively, the feature value may be calculated using a filter that calculates the intensity gradient, such as a Sobel or Laplacian filter, in order to obtain the feature value that emphasizes an image edge, or using a Gabor filter or the like in order to extract a particular pattern. Further alternatively, the feature value may be calculated using a Hessian in order to obtain the feature value that emphasizes a local structure within the window (for example, feature value as linear structure).

In addition to the above examples, the feature value acquisition function 130 may also acquire feature values related to the shape of the profile line (for example, the curvature of the profile line, direction of running, etc.) in order to capture changes in the shape of the pancreas. The feature value may be calculated using the intensity gradient or the local structure described above on the basis of the direction of travel of the profile line. For example, the relationship between the direction of travel of the profile line and the direction of the image edge may be used as the feature value because it is assumed that the pancreatic texture changes significantly at a place where the profile line intersects the image edge. In this case, the value of the feature value is increased when the image edge is closer in the direction orthogonal to the direction of travel of the profile line, and the value of the feature value is decreased when the image edge is closer in the direction of travel of the profile line. In this way, it is possible to specify the place with large texture changes on the profile line (abnormal region candidate) at steps S540 to S550.

The feature value acquisition function 130 may, in addition to calculating the feature value for localizing (detecting) the abnormal region candidate, calculate the feature value for eliminating a typical wrong detection pattern, and perform a process of eliminating the wrong detection pattern on the basis of the feature value.

In the description made above, the feature value change acquisition function 140 acquires the amount of change of the feature value from the voxel adjacent to the voxel of interest on the profile line; however, the present disclosure is not limited to this. For example, the amount of change of the feature value may be acquired from the voxel of interest and the voxel in the vicinity that is not adjacent to the voxel of interest, or the amount of change of the feature value may be acquired using the feature values for not just the voxel adjacent to the voxel of interest but also each of a plurality of voxels in the vicinity centering on the voxel of interest on the profile line. For the latter, for example, a method in which the amount of change is the difference between the weighted average value of the feature value for each of the voxels in the vicinity and the feature value of the voxel of interest is considered. In this way, the amount of change of the feature value becomes synonymous with the amount of shift of the average value of the feature values, and it becomes possible to localize the abnormal region candidate by the shift of the average value. Any other method may be used to calculate the local amount of change in the feature values of the voxels on the profile line.

In the above description, the abnormal region candidate localization function 150 localizes the ROI centering on the voxel the predetermined distance away from the voxel corresponding to the change point, as the abnormal region candidate; however, the ROI centering on the voxel corresponding to the change point may be used as the abnormal region candidate. The abnormal region candidate localization function 150 may localize, as the abnormal region candidate, the region including at least one of the voxel corresponding to the change point at which the amount of change satisfies the predetermined condition and the voxel the predetermined distance away from the change point.

In the description made above, the abnormal region candidate localization function 150 localizes the abnormal region candidate by the three-dimensional rectangular region; however, the ROI in any shape may be used. For example, a region expressed by an ellipsoid or a region expressed by any polygon may be used. A two-dimensional ROI may be used. Alternatively, the abnormal region candidate may be localized using a likelihood map that expresses the likelihood of the abnormal region candidate spreading concentrically about the reference voxel described at step S550. In this case, the likelihood map has a high likelihood near the reference voxel and a lower likelihood away from the reference voxel.

In the description made above, at step S550, the abnormal region candidate localization function 150 specifies the change point by performing the threshold determination about the amount of change of the feature value. However, the method of specifying the change point is not limited to this, and for example, the change point may be specified by a recognizer configured to specify the change point using, as input, the amount of change of the feature value along the profile line. The recognizer can be any recognizer based on machine learning, and examples thereof include a neural network trained using teacher data including the amount of change (input data) of the feature value along the profile line and the change point (correct data). In addition, the abnormal region candidate may be localized based on the results of the recognizer configured to localize the abnormal region candidate (or change point) using the amount of change of the feature value for the voxel on the profile line and the partial image data including the voxel as the input. One example of such a recognizer is a CNN trained using the teacher data including the partial image data including the voxel on the profile line (input data), the amount of change (input data), and the abnormal region candidate (correct data).

In the above description, the image recognition function 160 uses the CNN as the recognizer configured to be able to determine the abnormal region; however, for example, any of the following recognizers performing image recognition may be used: a recognizer based on a deep learning method other than CNN (for example, vision transformer, etc.), a recognizer based on machine learning other than deep learning (for example, support vector machine (SVM), random forecast, etc.), and a recognizer based on a pattern matching process not based on learning, etc. The recognizer may be a self-learning model that further updates its internal algorithm as the user provides feedback on the outcome. Mathematical models or other methods may be applied in place of the recognizer.

In the above description, the image recognition function 160 uses the recognizer configured to be able to determine whether the abnormal region candidate is the abnormal region; however, a recognizer configured to extract the abnormal region from the partial image data that includes the abnormal region candidate may be used. For example, the image recognition function 160 localizes the abnormal region from the partial image data including the abnormal region candidate by a recognizer trained using the teacher data including the partial image data of the CT image data including the abnormal region candidate (input data) and the image data representing the abnormal region (correct data). The recognizer is not limited to the aforementioned structure that uses the partial image data as the input data and may have any structure that can recognize the abnormal region on the basis of the abnormal region candidate. In other examples of the structure, the CT image data and the abnormal region candidate image data may be used as the input, or the image data obtained by performing a masking process on the CT image data with the abnormal region candidate may be used as the input.

In the above description, the display control function 170 controls so that the display 80 displays the abnormal region with a rectangular frame line; however, any display method can be used to display the abnormal region as long as the region can be identified on the display 80. For example, the abnormal region displayed on the display 80 may be painted with a predetermined color or indicated by an arrow or the like, or the partial image data including the abnormal region in the CT image data may be displayed on the display 80. The display color representing the abnormal region may be changed according to the amount of change of the feature value. Furthermore, as illustrated in FIG. 4, the profile line may be displayed while being overlapped on the CT image data. Alternatively, among the abnormal region candidates localized by the abnormal region candidate localization function 150, the region that was not localized as the abnormal region by the image recognition function 160 may be overlapped. In this case, for example, the region localized as the abnormal region and the region not localized as the abnormal region may be displayed in different colors or in different display modes.

In the above description, the information processing apparatus 100 calculates the local feature value (average value of the intensity of voxels in the window) at step S530 and acquires the amount of change of the feature value (differential value) at step S540; however, the effect of the present disclosure can be obtained even if the processing steps are reversed. In other words, in another possible procedure, the differential value of the voxel value in the direction of the profile line may be calculated and the average value of the differential values for the voxels in the window may be acquired. The calculation of the feature value from the image data and the calculation of the amount of change thereof do not need to be performed separately, and the feature value change acquisition function 140 may be configured to calculate the amount of change of the feature value directly from the image data.

In the present embodiment, the information processing apparatus 100 causes the display 80 to display the CT image data and the abnormal region image data through the display control function 170. However, such display control is not essential; for example, the abnormal region candidate may be saved in the storage 70 or transmitted to another information processing apparatus.

In the present embodiment, the information processing apparatus 100 determines whether the abnormal region candidate is the abnormal region through the image recognition function 160; however, the image recognition function 160 is not essential. As a structure without the image recognition function 160, for example, the information processing apparatus 100 performs the display control with the display control function 170 so that the abnormal region candidate localized by the abnormal region candidate localization function 150 is displayed on the CT image data in the overlapping manner. Note that the abnormal region candidate may be displayed by the same method as the method of displaying the abnormal region described above.

### Second Embodiment

### Summary

The present embodiment will describe a method for calculating the feature value for the cross section that intersects the profile line that runs in the pancreas to calculate the feature value along the profile line, and detecting the abnormal region candidate using the amount of change of the feature value.

### Function Structure

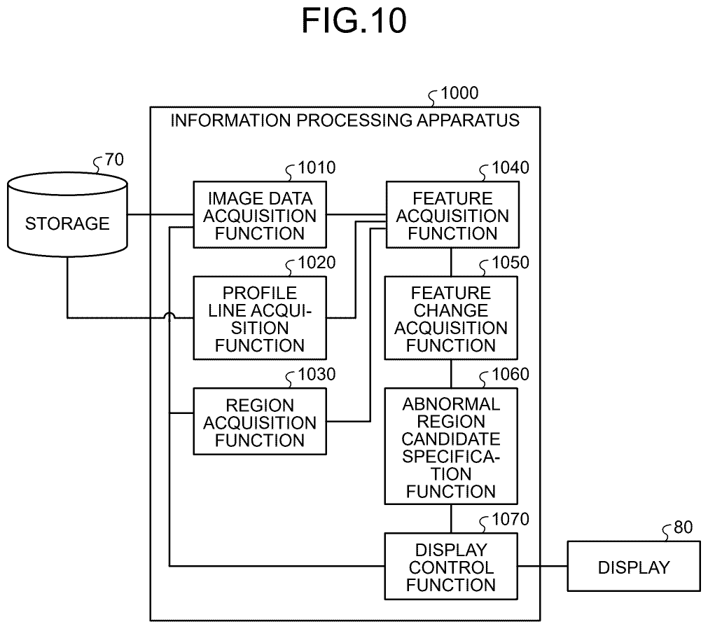

With reference to FIG. 10, a function structure of an information processing apparatus 1000 according to the present embodiment is described below. As illustrated in the drawing, the information processing apparatus 1000 includes an image data acquisition function 1010, a profile line acquisition function 1020, a region acquisition function 1030, a feature value acquisition function 1040, a feature value change acquisition function 1050, and an abnormal region candidate localization function 1060. The information processing apparatus 1000 according to the present embodiment also includes the storage 70 externally.

The description of the storage 70 and the display 80 is omitted because these components are similar to those in the first embodiment. The storage 70 and the display 80 may be included in the structure of the information processing apparatus 1000. In addition, the storage 70 may be provided inside the information processing apparatus 1000.

The image data acquisition function 1010 acquires the CT image data from the storage 70 and transmits the CT image data to the region acquisition function 1030, the feature value acquisition function 1040, and a display control function 1070.

The profile line acquisition function 1020 acquires the profile line data of the pancreas corresponding to the CT image data from the storage 70 and transmits the CT image data to the feature value acquisition function 1040.

The region acquisition function 1030 first receives the CT image data from the image data acquisition function 1010. Next, the region acquisition function 1030 extracts a pancreatic region on the CT image data and generates data representing the pancreatic region (hereinafter referred to as pancreatic region data). The region acquisition function 1030 then transmits the pancreatic region data to the feature value acquisition function 1040. The pancreatic region on the CT image data is one example of a target region for acquiring the feature value in the present embodiment.

Here, the pancreatic region data is described. The pancreatic region data is the image data that indicates whether each voxel is the voxel included in the pancreas. For example, the pancreatic region data is a binary image with the same image size as the CT image data, in which the voxel included in the pancreas is expressed as a voxel value of 1 and the voxel not included in the pancreas is expressed as a voxel value of 0. The pancreatic region data can be in any format as long as the region of the pancreas depicted on the CT image data can be identified. Therefore, the pancreatic region data may be the likelihood image data in which the voxel value of each voxel expresses the uniqueness of the pancreatic region. The pancreatic region data may be multi-value image data in which the voxel value of each voxel expresses regions of various tissues including the pancreas in multiple values. Alternatively, the pancreatic region data may be text data that approximates the shape of the pancreas as a polygon and holds the coordinate values of its vertices. The pancreatic region data is, in other words, data that can localize the target region.

The feature value acquisition function 1040 acquires the feature value on the basis of the target region in the cross-sectional image data intersecting the profile line. More specifically, the feature value acquisition function 1040 first receives the CT image data from the image data acquisition function 1010, receives the profile line data of the pancreas corresponding to the CT image data from the profile line acquisition function 1020, and receives the pancreatic region data corresponding to the CT image data from the region acquisition function 1030. Next, the feature value acquisition function 1040 calculates the feature value for each of the cross sections that intersect the profile line in the CT image data, and acquires the feature values along the profile line. For example, the feature value acquisition function 1040 in the present embodiment acquires the feature value for at least one cross-sectional image data that intersects the profile line among the pieces of CT image data, which is the three-dimensional tomographic image data. The CT image data includes a plurality of pieces of cross-sectional image data. The feature value acquisition function 1040 then transmits the feature values along the profile line to the feature value change acquisition function 1050.

The feature value change acquisition function 1050 first receives the feature value along the profile line from the feature value acquisition function 1040. Next, the feature value change acquisition function 1050 acquires the amount of change of the feature value by calculating the amount of change in the local feature values with respect to the feature value along the profile line, similarly to the first embodiment. The feature value change acquisition function 1050 then transmits the amount of change of the feature value to the abnormal region candidate localization function 1060.

The abnormal region candidate localization function 1060 first receives the amount of change of the feature value from the feature value change acquisition function 1050. Next, in a manner similar to the first embodiment, the abnormal region candidate localization function 1060 specifies the change point at which the amount of change of the feature value satisfies the predetermined condition, and localizes (detects) the region including the change point as the abnormal region candidate. Then, the abnormal region candidate localization function 1060 generates the abnormal region candidate image data and transmits the abnormal region candidate image data to the display control function 1070.

The display control function 1070 first receives the CT image data from the image data acquisition function 1010 and receives the abnormal region candidate image data from the abnormal region candidate localization function 1060. The display control function 1070 then causes the display 80 to display the CT image data and the abnormal region image data. Hardware structure

The hardware structure of the information processing apparatus 1000 in the present embodiment is the same as that of the first embodiment; therefore, the description is omitted.

### Procedure of Process

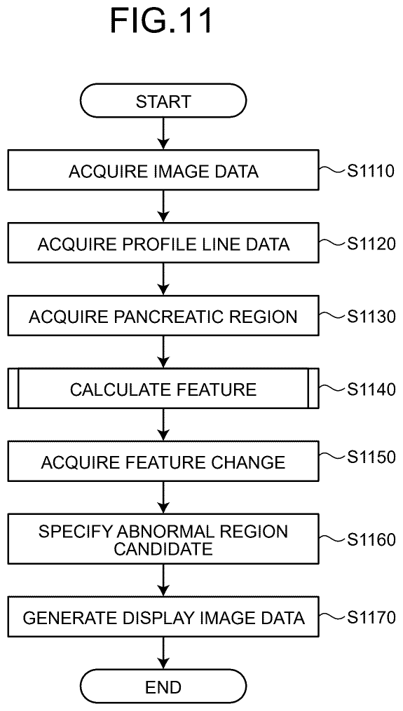

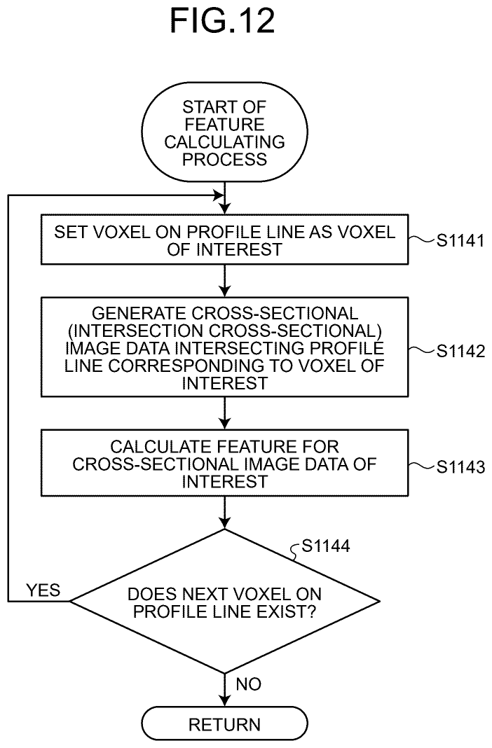

Next, the procedure of the process of the information processing apparatus 1000 in the present embodiment is described with reference to FIG. 11 and FIG. 12. FIG. 11 is a flowchart expressing one example of the procedure of the process of the information processing apparatus 1000 according to the second embodiment. FIG. 12 is a flowchart expressing one example of the procedure of a feature value calculating process according to the second embodiment. The description of the part overlapping with that of the information processing apparatus 100 according to the first embodiment will be omitted below.

### Step S1110

Since step S1110 is the same as step S510 in the first embodiment, the description is omitted.

### Step S1120

Since step S1120 is the same as step S520 in the first embodiment, the description is omitted.

### Step S1130

At step S1130, the region acquisition function 1030 first receives the CT image data from the image data acquisition function 1010. Next, the region acquisition function 1030 extracts the pancreatic region on the CT image data and generates the pancreatic region data. The region acquisition function 1030 then transmits the pancreatic region data to the feature value acquisition function 1040.

In the present embodiment, the region acquisition function 1030 extracts the pancreatic region on the CT image data using a recognizer based on machine learning configured to extract the pancreatic region using the CT image data as the input. The aforementioned recognizer is, for example, a trained CNN, which is trained by a known method such as error back-propagation using, for example, teacher data including the CT image data and the correct pancreatic region data corresponding to the CT image data. The recognizer may be any recognizer that extracts the pancreatic region on the CT image data. For example, the recognizer may be based on machine learning, such as SVM or Random Forest, or may be based on image processing, such as region expansion, graph cut segmentation, or threshold processing. The recognizer may be a self-learning model that further updates its internal algorithm as the user provides feedback on the outcome. The recognizer is one example of an inference model based on machine learning in the present embodiment. Mathematical models or other methods may be applied in place of the recognizer.

### Step S1140

At step S1140, the feature value acquisition function 1040 first receives the CT image data from the image data acquisition function 1010, and receives the pancreatic profile line data and the pancreatic region data corresponding to the CT image data from the profile line acquisition function 1020 and the region acquisition function 1030, respectively. Next, the feature value acquisition function 1040 calculates the feature value for each of the cross sections that intersect the profile line in the CT image data, and acquires the feature values along the profile line. The feature value acquisition function 1040 then transmits the feature values along the profile line to the feature value change acquisition function 1050.

Here, with reference to the flowchart in FIG. 12, the details of the process of calculating the feature value at step S1140 in the present embodiment are described.

### Step S1141

At step S1141, the feature value acquisition function 1040 sets any voxel on the profile line as a voxel of interest. The present embodiment will describe the case in which the feature values for the voxels on the profile line are calculated in the order from the pancreatic head to the pancreatic tail. The feature value acquisition function 1040 first sets the voxel at the end on the pancreatic head side among the voxels on the profile line as the voxel of interest.

### Step S1142

At step S1142, the feature value acquisition function 1040 generates the cross-sectional image data that intersects the profile line at the voxel of interest (hereinafter referred to as intersection cross-sectional image data). In the present embodiment, the intersection cross-sectional image data is generated from each of the CT image data and the pancreatic region data using the tangent vector of the profile line at the voxel of interest as the normal vector. The intersection cross-sectional image data generated from the CT image data is referred to as CT intersection cross-sectional image data below, and the intersection cross-sectional image data generated from the pancreatic region data is referred to as pancreatic intersection cross- sectional image data below.

### Step S1143

At step S1143, the feature value acquisition function 1040 calculates the feature value for the voxel of interest on the basis of the CT intersection cross-sectional image data and the pancreatic intersection cross-sectional image data. More specifically, the average value of the intensity of the pancreatic region in the CT intersection cross-sectional image data is calculated, and this is used as the feature value for the voxel of interest. The pancreatic region in the CT intersection cross-sectional image data can be specified by referring to the pancreatic intersection cross-sectional image data. Note that the average value of the intensity of the pancreatic region is one example of the statistic (statistical value) of the intensity of the pancreatic region, and the feature value to be acquired by the feature value acquisition function 1040 may be the statistic (statistical value) of the intensity of the pancreatic region other than the average value (for example, at least one of minimum value, maximum value, median value, variance value, and weighted average value). The statistic of the intensity of the pancreatic region on each cross section in the CT intersection cross-sectional image data can be paraphrased as the statistic of the intensity near the profile line.

### Step S1144

At step S1144, the feature value acquisition function 1040 determines whether the next voxel on the profile line exists, and if the next voxel does not exist, terminates step S1140, and if otherwise, the process returns to step S1141 and the next voxel is set as the voxel of interest. In other words, step S1140 is terminated when the feature values are calculated for all voxels on the profile line on the basis of the cross section that intersects the profile line.

In the present embodiment, the feature values for the voxels on the profile line are calculated in the order from the pancreatic head to the pancreatic tail; therefore, the next voxel is the voxel that has advanced in the direction of the pancreatic tail from the current voxel of interest. The voxel of interest at the end of step S1140 is the voxel at the end on the pancreatic tail side among the voxels on the profile line.

By step S1140 described above, the feature value acquisition function 1040 acquires the feature values along the profile line as illustrated in FIG. 7. The value of the feature value in the drawing corresponds to the average value of the intensity of the pancreatic region in the cross section that intersects the profile line in the present embodiment.

### Step S1150

Referring back to FIG. 11, since step S1150 is the same as step S540 in the first embodiment, the description is omitted.

### Step S1160

At step S1160, the abnormal region candidate localization function 1060 first receives the amount of change of the feature value from the feature value change acquisition function 1050. Next, in a manner similar to the first embodiment, the abnormal region candidate localization function 1060 specifies the change point at which the amount of change of the feature value satisfies the predetermined condition, and localizes (detects) the region including the change point as the abnormal region candidate. Then, the abnormal region candidate localization function 1060 generates the abnormal region candidate image data and transmits the abnormal region candidate image data to the display control function 1070.

### Step S1170

At step S1170, the display control function 1070 first receives the CT image data from the image data acquisition function 1010 and receives the abnormal region candidate image data from the abnormal region candidate localization function 1060. The display control function 1070 then causes the display 80 to display the CT image data and the abnormal region image data.

In the present embodiment, the display control function 1070 causes the display 80 to display so that a rectangular frame line that surrounds the abnormal region candidate (ROI) held by the abnormal region candidate image data is overlapped on the CT image data 300. Other display methods for the abnormal region candidate are similar to the method used to display the abnormal region in the first embodiment.

With the above procedure of the process, the information processing apparatus 1000 calculates the amount of change of the intensity value of the pancreatic region in the cross section intersecting the profile line on the basis of the CT image data and the pancreatic profile line data, and localizes the abnormal region candidate in the pancreas on the basis of the amount of change. Then, for the localized abnormal region candidate, it is determined whether the region is abnormal. In this manner, it is possible to capture changes within the pancreas, such as indirect findings of pancreatic cancer; therefore, it is expected to improve the detection performance of obscure pancreatic cancer.

In the above description, the region acquisition function 1030 acquires the pancreatic region data representing the region of the pancreas on the CT image data by using the recognizer; however, the present disclosure is not limited to this. For example, the pancreatic region data corresponding to the CT image data generated in advance may be acquired from the storage 70, or the pancreatic region data corresponding to the CT image data may be acquired from another information processing apparatus. In addition to the pancreatic region data, the region acquisition function 1030 may also acquire pancreatic duct region data representing the region of the pancreatic duct. That is to say, the region of the pancreatic duct may be one example of the target region related to the pancreas. In this case, when calculating the feature value from the cross section that intersects the profile line, for example, the feature value acquisition function 1040 can calculate the feature value from just the pancreatic region (region of the pancreatic parenchyma), excluding the region of the pancreatic duct. Accordingly, it is expected to improve the detection accuracy of pancreatic cancer because minute changes in the pancreatic parenchyma can be captured. The region acquisition function 1030 is to, for example, acquire at least one of the pancreatic region and the pancreatic duct region as the target region related to the pancreas.

In the above description, the feature value acquisition function 1040 calculates the feature value related to the intensity of the pancreas; however, the feature value related to the shape of the pancreas may be acquired. For example, the feature value acquisition function 1040 may acquire the area, circumferential length, major diameter, minor diameter, average diameter, or the like of the pancreatic region on the intersection cross-sectional image data as the feature value. The area and circumferential length of the pancreatic region on the intersection cross-sectional image data are examples of the area and circumferential length of the target region in the present embodiment, respectively. The major, minor, and average diameters of the pancreatic region on the intersection cross-sectional image data are examples of the diameters of the target region in the present embodiment. By using the feature value as above, the feature value acquisition function 1040 can capture localized stenosis of the pancreas, which is one of the indirect findings of the pancreatic cancer. The feature value related to the shape of the pancreas may also be the feature value that expresses the feature value of the cross-sectional shape, such as flatness or circularity. The feature value acquisition function 1040 may also acquire the feature value using any filter (Sobel filter, Gabor filter, etc.) or Hessian as described in the first embodiment for the intersection cross-sectional image data. The feature value acquisition function 1040 may also use a combination of the feature values including the intensity and shape of the pancreas described above, and the feature values obtained by any filter and the like. In this case, for example, at step S1150, the information processing apparatus 1000 calculates the amount of change for each of the feature values, and at step S1160, localizes the abnormal region candidate by using the threshold corresponding to each amount of change of the feature value. Alternatively, the feature value acquisition function 1040 may use the result of integrating the feature values as the feature value for the voxel on the profile line.

In the above description, the feature value acquisition function 1040 calculates the feature value for each piece of the intersection cross-sectional image data for the profile line; however, the feature value may be calculated for the pieces of intersection cross-sectional image data for the profile line. In this case, the pieces of intersection cross-sectional image data may be either continuous (adjacent) intersection cross-sectional image data or discontinuous (not adjacent) intersection cross-sectional image data. When the feature values are calculated from the pieces of intersection cross-sectional image data, the step width relative to the profile line when calculating the feature value along the profile line may be either smaller or larger than the number of pieces of intersection cross-sectional image data. That is to say, the pieces of intersection cross-sectional image data when calculating feature value may or may not overlap with the pieces of intersection cross-sectional image data when calculating the adjacent feature value. The feature value may also be calculated for a slab image with a certain thickness in the intersection cross section relative to the profile line.

In the description made above, the feature value acquisition function 1040 generates the intersection cross-sectional image data for the profile line when calculating the feature value. However, the feature value acquisition function 1040 may calculate the feature value by selectively using voxels in the target region the feature value of which is to be calculated, without explicitly generating the intersection cross-sectional image data.

In the above description, the display control function 1070 causes the display 80 to display the abnormal region candidate on the CT image data by the same method as that in the first embodiment; however, the display 80 may display partial image data including the CT intersection cross-sectional image data corresponding to the abnormal region candidate. In this case, the pancreatic intersection cross-sectional image data may be displayed while being overlapped on the partial image data including the CT intersection cross-sectional image data corresponding to the abnormal region candidate. Alternatively, a curved planar reconstruction (CPR) image may be generated such that the profile line of the pancreas is depicted in one cross section, and the abnormal region candidate may be displayed while being overlapped on the CPR image.

In the above description, the information processing apparatus 1000 causes the region acquisition function 1030 to extract the pancreatic region from the CT image data; however, the pancreatic region may be extracted from the CT intersection cross-sectional image data generated at step S1142. In this case, for example, by the process performed in the region acquisition function 1030 in the present embodiment, the feature value acquisition function 1040 extracts the pancreatic region from the CT intersection cross-sectional image data. Alternatively, the feature value acquisition function 1040 may be configured to calculate the feature value only from voxels with intensity values that the pancreas can have, without explicitly extracting the pancreatic region.

In the above description, the information processing apparatus 1000 calculates the feature value along the profile line at step S1140 and calculates the amount of change of the feature value along the profile line at step S1150; however, the procedure of the process may be reversed. In other words, the amount of change (for example, difference) relative to the CT intersection cross-sectional image data along the profile line may be calculated first, and then the feature value may be calculated with respect to the amount of change. Even with this procedure of the process, the effect of the present disclosure can be obtained.

### Third Embodiment

### Summary

While the first embodiment describes the method for calculating the feature value along the profile line that runs through the pancreas and detecting the abnormal region candidate by using the amount of change of the feature value, the present embodiment will describe a method for detecting the abnormal region candidate by using the value of the feature value itself.

More specifically, for each of the voxels on the profile line, the information processing apparatus according to the present embodiment acquires the degree of stenosis of the pancreas around that position as the feature value along the profile line in the pancreas. When the feature value along the profile line is more than or equal to the predetermined threshold, the information processing apparatus detects the region as the abnormal region candidate.

### Function Structure

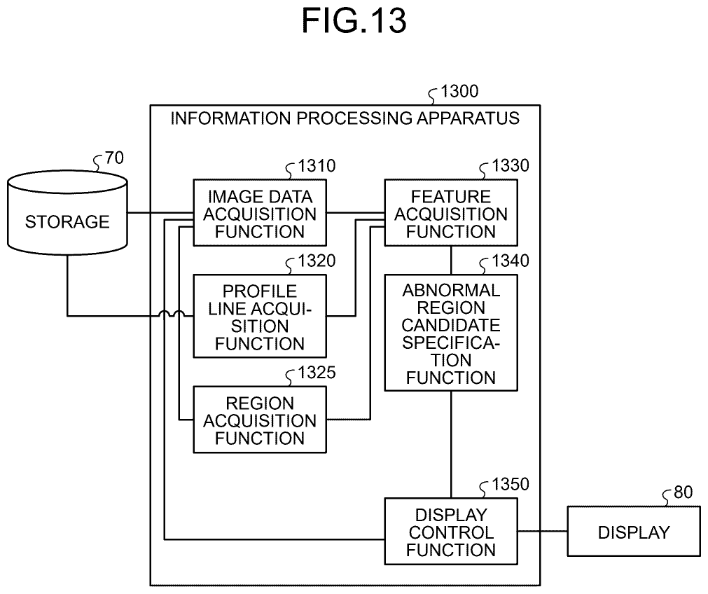

A function structure of an information processing apparatus 1300 according to the present embodiment is described below with reference to FIG. 13. As illustrated in the drawing, the information processing apparatus 1300 includes an image data acquisition function 1310, a profile line acquisition function 1320, a region acquisition function 1325, a feature value acquisition function 1330, an abnormal region candidate localization function 1340, and a display control function 1350. The information processing apparatus 1300 according to the present embodiment also includes a storage 70 and a display 80 externally.

Since the storage 70 and the display 80 are similar to the storage 70 in the first embodiment, the description is omitted. The storage 70 and the display 80 may be included in the structure of the information processing apparatus 1300. In addition, the storage 70 may be provided inside the information processing apparatus 1300.

The image data acquisition function 1310 acquires the CT image data from the storage 70 and transmits the CT image data to the feature value acquisition function 1330 and the display control function 1350.

The profile line acquisition function 1320 acquires the profile line data of the pancreas corresponding to the CT image data from the storage 70 and transmits the CT image data to the feature value acquisition function 1330.

The region acquisition function 1325 first receives the CT image data from the image data acquisition function 1310. Next, the region acquisition function 1325 extracts the pancreatic region on the CT image data and generates data representing the pancreatic region (hereinafter referred to as pancreatic region data). The region acquisition function 1325 then transmits the pancreatic region data to the feature value acquisition function 1330 and the display control function 1350.

The feature value acquisition function 1330 first receives the CT image data from the image data acquisition function 1310, receives the profile line data of the pancreas corresponding to the CT image data from the profile line acquisition function 1320, and receives the pancreatic region data corresponding to the CT image data from the region acquisition function 1325. Next, the feature value acquisition function 1330 calculates the feature values along the profile line from the CT image data on the basis of the profile line data. The feature value acquisition function 1330 then transmits the feature values along the profile line to the abnormal region candidate localization function 1340.

The abnormal region candidate localization function 1340 first receives the feature value along the profile line from the feature value acquisition function 1330. Next, the abnormal region candidate localization function 1340 specifies the voxel on the profile line at which the value of the feature value satisfies the predetermined condition, and localizes (detects) the region including the voxel on the profile line as the abnormal region candidate. Then, the abnormal region candidate localization function 1340 generates the abnormal region candidate image data and transmits the abnormal region candidate image data to the display control function 1350.

The display control function 1350 first receives the CT image data from the image data acquisition function 1310 and receives the abnormal region candidate from the abnormal region candidate localization function 1340. The display control function 1350 then causes the display 80 to display the CT image data and the abnormal region candidate.

### Hardware Structure

The hardware structure of the information processing apparatus 1300 in the present embodiment is the same as that of the first embodiment; therefore, the description is omitted.

### Procedure of Process

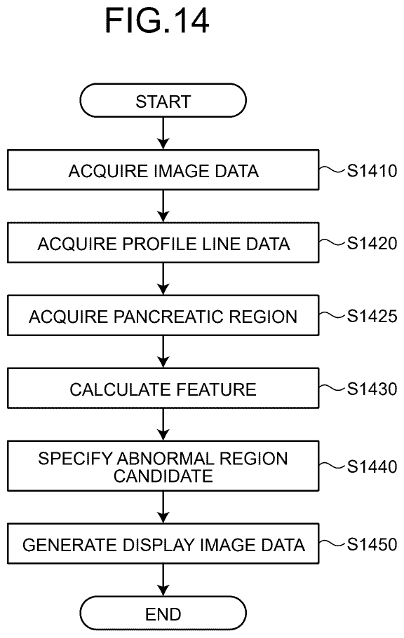

Next, the procedure of the process of the information processing apparatus 1300 in the present embodiment is described with reference to FIG. 14. FIG. 14 is a flowchart expressing one example of the procedure of the process of the information processing apparatus 1300 according to the third embodiment. The description of the part overlapping with that of the information processing apparatus 100 according to the first embodiment will be omitted below.

### Step S1410

At step S1410, the image data acquisition function 1310 acquires the CT image data from the storage 70 and transmits the CT image data to the feature value acquisition function 1330 and the display control function 1350.

### Step S1420

At step S1420, the profile line acquisition function 1320 acquires the profile line data of the pancreas corresponding to the CT image data from the storage 70 and transmits the CT image data to the feature value acquisition function 1330.

### Step S1425

At step S1425, the region acquisition function 1325 first receives the CT image data from the image data acquisition function 1310. Next, the region acquisition function 1325 extracts the pancreatic region on the CT image data and generates the pancreatic region data. The region acquisition function 1325 then transmits the pancreatic region data to the feature value acquisition function 1330 and the display control function 1350.

At this processing step, the process to be performed by the region acquisition function 1325 is similar to that at step S1130 performed by the region acquisition function 1030 in the second embodiment. The detailed explanation is omitted here.

### Step S1430

At step S1430, the feature value acquisition function 1330 first receives the CT image data from the image data acquisition function 1310, and receives the pancreatic profile line data and the pancreatic region data corresponding to the CT image data from the profile line acquisition function 1320 and the region acquisition function 1325, respectively. Next, the feature value acquisition function 1330 calculates the feature values along the profile line from the CT image data on the basis of the profile line data. In the present embodiment, the feature value related to the shape of the pancreas is calculated as the feature value along the profile line. Specifically, the degree to which the shape of the pancreas on the intersection cross- sectional image data is narrowed in the direction of travel of the profile line is calculated as the feature value. The procedure of the process will be described below more specifically.

First, the feature value acquisition function 1330 sets any voxel on the profile line as a voxel value of interest and generates cross-sectional image data intersecting the profile line at that voxel. The cross-sectional image data generated by the feature value acquisition function 1330 here are a plurality of pieces of cross-sectional image data along the direction of the tangent vector of the profile line. As one example, the feature value acquisition function 1330 acquires a total of three pieces of tomographic data including a tomographic image centered on the voxel position described above (central tomographic image) and two tomographic images before and after the voxel position that are separated by a predetermined interval in the tangent direction of the profile line (front and rear tomographic images).

Next, the average diameter of the pancreatic regions on the tomographic image data is calculated for each of the three pieces of generated tomographic image data. If the average diameter in the central tomographic image data is smaller than the average diameter in the front and rear tomographic image data, the feature value with a large value is calculated as the degree of stenosis is large. On the contrary, if the average diameter in the central tomographic image is larger than or equal to the average diameter in the front and rear tomographic images, the feature value with a small value is calculated as the degree of stenosis is small.

### Step S1440

At step S1440, the abnormal region candidate localization function 1340 first receives the feature value along the profile line from the feature value acquisition function 1330. Next, the abnormal region candidate localization function 1340 specifies the voxel on the profile line at which the value of the feature value satisfies the predetermined condition, and localizes (detects) the region including the voxel on the profile line as the abnormal region candidate. Then, the abnormal region candidate localization function 1340 generates the abnormal region candidate image data and transmits the abnormal region candidate image data to the display control function 1350.

As illustrated in FIG. 3, stenosis may occur in the shape of the pancreas around the region where pancreatic cancer is present. Therefore, the abnormal region candidate localization function 1340 in the present embodiment localizes the abnormal region candidate using the condition that the feature value (degree of stenosis) calculated at step S1430 is more than or equal to a predetermined value as the predetermined condition. More specifically, the abnormal region candidate localization function 1340 in the present embodiment first specifies the voxel corresponding to the section A as the voxel on the profile line that satisfies the aforementioned condition. In other words, the abnormal region candidate localization function 1340 specifies the voxel for which the value of the feature value is more than or equal to the predetermined value. Then, the abnormal region candidate localization function 1340 localizes the abnormal region candidate by using the ROI in any size that includes the voxel on the profile line. In the present embodiment, as the ROI in any size, a three-dimensional rectangular ROI with the length of one side being the length of consecutive voxels (section A) on the profile line that satisfy the predetermined condition is used. Since the feature value in the present embodiment is the degree of stenosis of the pancreas, the abnormal region candidate localization function 1340 may localize, as the abnormal region candidate, the local stenosis of the pancreas corresponding to the indirect finding of the pancreatic cancer or the region where the pancreatic cancer is suspected as described in the first embodiment, for example.

### Step S1450

At step S1450, the display control function 1350 first receives the CT image data from the image data acquisition function 1310 and receives the abnormal region candidate image data from the abnormal region candidate localization function 1340. The display control function 1350 then causes the display 80 to display the CT image data and the abnormal region image data. The details of the process are similar to those at step S1170 in the second embodiment and are therefore omitted.

With the above procedure of the process, the information processing apparatus 1300 calculates the feature value along the profile line on the basis of the CT image data and the profile line data of the pancreas, and localizes the abnormal region candidate in the pancreas on the basis of the feature value along the profile line. In this manner, changes within the pancreas can be captured and therefore, even the obscure pancreatic cancer can be localized (detected).

### Variation of Third Embodiment

The feature value acquisition function 1330 may obtain the feature value representing the degree of pancreatic stenosis by methods other than those described above. For example, the diameter or area of the pancreas in each intersection cross-sectional image that intersects the profile line may be used as the degree of stenosis. A discriminator that infers the degree of stenosis with the input of each intersection cross-sectional image intersecting the profile line may be constructed by deep learning, and estimation may be conducted by the output of the discriminator. In addition to the degree of stenosis, values indicating anomalies in the shape of the pancreas (for example, flatness or deviation from circularity) may also be used as the feature value.

Alternatively, the feature value based on the shape of the target region related to the pancreas, other than the pancreatic region, may be used. For example, the pancreatic duct may be used as the target region, and the feature value based on the shape of the pancreatic duct may be used. For example, the diameter and area of the pancreatic duct in each intersection cross-sectional image that intersects the profile line may be used as the feature value to localize the vicinity of the location where the pancreatic duct is disrupted as the abnormal region candidate.

In the description made above, the feature value acquisition function 1330 calculates the feature value based on the shape of the pancreas; however, the present disclosure is not limited to this. For example, the feature value may be calculated based on the intensity value of the voxel on the profile line or based on the statistic of the intensity of the voxel near the voxel on the profile line. In this case, the abnormal region candidate localization function 1340 may specify the voxels with the feature value out of a predetermined range. In addition to this, for example, the difference value between the average value of the feature values in the CT image data and the value of the feature value for a certain voxel on the profile line may be calculated, and then by performing a threshold determination on this difference value, the voxel may be specified. Any other method to specify the voxel with the feature value that is an outlier may be used.

In each of the above embodiments, the pancreas is described as an example; however, the abnormal region candidate may be detected by applying a method realized by each functional unit of the information processing apparatuses 100 and 1000 in the above embodiments to anatomical tissues other than the pancreas, such as other parenchymal organs.

Note that various kinds of data handled herein are typically digital data.

According to at least one of the embodiments described above, the accuracy of detecting abnormal region candidate such as pancreatic cancer can be improved.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising processing circuitry configured to:
acquire three-dimensional tomographic image data in which a pancreas is depicted;
acquire profile line data that is able to specify a profile line running in the pancreas corresponding to the three-dimensional tomographic image data;
acquire a feature value along the profile line corresponding to the three-dimensional tomographic image data;
acquire an amount of change in a plurality of the feature values along the profile line; and
localize an abnormal region candidate, based on the amount of change.

2. The information processing apparatus according to claim 1, wherein
the three-dimensional tomographic image data includes a plurality of pieces of cross-sectional image data, and
the processing circuitry is configured to acquire the feature value for at least one piece of cross-sectional image data that intersects the profile line in the three-dimensional tomographic image data.

3. The information processing apparatus according to claim 2, wherein the processing circuitry is configured to acquire the feature value for the pieces of cross-sectional image data that intersect the profile line.

4. The information processing apparatus according to claim 1, wherein the processing circuitry is configured to acquire a value based on a voxel value on the profile line, as the feature value.

5. The information processing apparatus according to claim 1, wherein the processing circuitry is configured to acquire the amount of change, based on a value obtained by first derivation of the feature values along the profile line.

6. The information processing apparatus according to claim 1, wherein the processing circuitry is configured to localize, as the abnormal region candidate, a region including at least one of a voxel corresponding to a change point at which the amount of change satisfies a predetermined condition and a voxel corresponding to a position a predetermined distance away from the change point.

7. The information processing apparatus according to claim 1, wherein the processing circuitry is configured to
acquire at least one of a pancreatic region and a pancreatic duct region as a target region from which the feature value in the three-dimensional tomographic image data is acquired, and
acquire the feature value, based on the target region in the cross-sectional image data intersecting the profile line.

8. The information processing apparatus according to claim 7, wherein the processing circuitry is configured to acquire, as the feature value, a feature value based on a statistic of intensity of the target region in the cross-sectional image data.

9. The information processing apparatus according to claim 8, wherein the processing circuitry is configured to acquire the feature value based on at least one of an average value, a maximum value, a minimum value, a median value, and a variance value as the statistic of the intensity of the target region in the cross-sectional image data.

10. The information processing apparatus according to claim 7, wherein the processing circuitry is configured to acquire, as the feature value, a feature value about a shape of the target region in the cross-sectional image data.

11. The information processing apparatus according to claim 10, wherein the processing circuitry is configured to acquire, as the feature value, at least one of an area, a circumferential length, and a diameter of the target region in the cross-sectional image data.

12. The information processing apparatus according to claim 1, wherein the processing circuitry is configured to perform image recognition for the abnormal region candidate using an inference model based on machine learning.

13. The information processing apparatus according to claim 1, further comprising a display, wherein
the processing circuitry is configured to cause the display to display, in such a manner that identification is possible, at least one of the abnormal region candidate and an image recognition result corresponding to a result of image recognition for the abnormal region candidate.

14. The information processing apparatus according to claim 13, wherein the display control function is configured to cause the display to display the abnormal region candidate for the three-dimensional tomographic image data.

15. The information processing apparatus according to claim 13, wherein the processing circuitry is configured to cause the display to display the cross-sectional image data including the abnormal region candidate.

16. An information processing apparatus comprising processing circuitry configured to:
acquire three-dimensional tomographic image data in which a pancreas is depicted;
acquire profile line data that is able to specify a profile line running in the pancreas corresponding to the three-dimensional tomographic image data;
acquire, as a feature value, a statistic of intensity near the profile line corresponding to the three-dimensional tomographic image data; and
localize an abnormal region candidate, based on the feature value.

17. An information processing method comprising:
acquiring three-dimensional tomographic image data in which a pancreas is depicted;
acquiring profile line data that is able to specify a profile line running in the pancreas corresponding to the three-dimensional tomographic image data;
acquiring a feature value along the profile line corresponding to the three-dimensional tomographic image data;
acquiring an amount of change in a plurality of the feature values along the profile line; and
localizing an abnormal region candidate, based on the amount of change.

18. An information processing method comprising:
acquiring three-dimensional tomographic image data in which a pancreas is depicted;
acquiring profile line data that is able to specify a profile line running in the pancreas corresponding to the three-dimensional tomographic image data;
acquiring, as a feature value, a statistic of intensity near the profile line corresponding to the three-dimensional tomographic image data; and
localizing an abnormal region candidate, based on the feature value.

19. A storage medium storing, in a non-transitory manner, a computer program causing a computer to execute:
acquiring three-dimensional tomographic image data in which a pancreas is depicted;
acquiring profile line data that is able to specify a profile line running in the pancreas corresponding to the three-dimensional tomographic image data;
acquiring a feature value along the profile line corresponding to the three-dimensional tomographic image data;
acquiring an amount of change in a plurality of the feature values along the profile line; and
localizing an abnormal region candidate near the profile line in the pancreas, based on the amount of change.

20. A storage medium storing, in a non-transitory manner, a computer program causing a computer to execute:
acquiring three-dimensional tomographic image data in which a pancreas is depicted;
acquiring profile line data that is able to specify a profile line running in the pancreas corresponding to the three-dimensional tomographic image data;
acquiring, as a feature value, a statistic of intensity near the profile line corresponding to the three-dimensional tomographic image data; and
localizing an abnormal region candidate, based on the feature value.
